(19) United States
(12) Patent Application Publication
(10) Pub. No.: US 2020/0133562 A1
(43) Pub. Date: Apr. 30, 2020

(54) INFORMATION PROCESSING DEVICE, CONTROLLING METHOD AND PROGRAM

(71) Applicant: LENOVO (SINGAPORE) PTE. LTD., SINGAPORE (SG)

(72) Inventors: Yusaku Morishige, YOKOHAMA (JP); Mikio Hagiwara, YOKOHAMA (JP); Ken Sasaki, YOKOHAMA (JP); Naoyuki Araki, YOKOHAMA (JP)

(73) Assignee: LENOVO (SINGAPORE) PTE. LTD., SINGAPORE (SG)

(21) Appl. No.: 16/270,550

(22) Filed: Feb. 7, 2019

(30) Foreign Application Priority Data
Oct. 31, 2018 (JP) 2018204789

(51) Int. Cl. G06F 3/06; G06F 9/4401; G06F 12/02

(52) U.S. Cl. CPC G06F 3/0655; G06F 3/0679; G06F 12/0253; G06F 3/061; G06F 9/4403; G06F 3/0652

(57) ABSTRACT

An information processing device includes a processing section configured to execute processing on the basis of a predetermined program and to write data which is necessary to execute the processing into a specific data area in a nonvolatile memory, a display control section configured to output display information to be displayed on a display unit on the basis of the processing executed by the processing section, and a memory control section configured to erase invalid data which is unnecessary at least for the processing of data which is written in the specific data area on the basis of transition from a first state where the processing by the processing section is being executed to a second state where at least the display control section does not output the display information.

### FIELD OF THE INVENTION

The present invention relates to an information processing device, a controlling method and a program.

### BACKGROUND OF THE INVENTION

In computer systems, there is one computer system configured to utilize a nonvolatile memory such as an SPI (Serial Peripheral Interface) flash memory and so forth as a data saving destination. A BIOS (Basic Input Output System) area in the flash memory includes an area in which a code of the BIOS is to be saved and a data save area (a variable area) in which data is to be saved. Not only BIOS setup information which is necessary for POST (Power On Self Test) processing to be executed when booting through the BIOS is saved in the data save area, but also various kinds of data are written into and read out of the data save area in accordance with a software program such as an OS (Operating System) and so forth also after execution of the POST processing.

Here, the above-described data save area is a specific data area which is set in advance in the flash memory and is a finite area. Updating of the same data is performed by invalidating previously written data and writing data (valid data) into new areas in the data save area. Therefore, an amount of data written in the data save area is increased and a free capacity of the data save area is decreased every time the data is updated. When the free capacity of the data save area becomes insufficient, there are cases where it becomes impossible to normally continue a process which is being executed and, for example, BSOD (Blue Screen of Death) that error information is displayed on a blue screen occurs. Accordingly, a technique of increasing the free capacity of the data save area in the flash memory by executing a garbage collection process of erasing unnecessary data which is written in the data save area, sorting out respective pieces of data and saving only the latest data is disclosed (see, for example, Japanese Patent Application Laid-Open No. 2014-132505).

### SUMMARY OF THE INVENTION

However, in recent years, the time taken for execution of the garbage collection process is becoming longer due to high functionality of processes which are executed by a computer. Since the garbage collection process is executed through SMI (System Management Interrupt), the garbage collection process occupies a CPU (Central processing Unit) and the CPU becomes unable to execute other processes. Therefore, the garbage collection process is not executed in a normal operating state and the garbage collection process is becoming to be executed only in POST processing that influence is little even when execution of other processes becomes impossible temporarily.

However, a utilization method of using again the computer simply by bringing the computer into a standby (or sleep) mode without performing a shutdown when the computer is not used is becoming common. In this utilization method, the frequency that the computer is shut down is low and therefore the number of opportunities that the POST processing is executed is reduced and then the number of opportunities that the garbage collection process is executed is reduced. When the computer is used continuously in a state of not being shut down, the free capacity of the data save area becomes insufficient eventually and therefore although data reading is possible, data updating and new data writing become impossible. There is a fear that it may become impossible to execute a process of saving data in the flash memory in this way.

The present invention has been made in view of the above-described circumstances and aims to provide an information processing device, a controlling method and a program making it possible to appropriately control the process of saving data in the nonvolatile memory.

The present invention has been made in order to solve the above-described issues. An information processing device according to the first aspect of the present invention includes a processing section configured to execute processing on the basis of a predetermined program and to write data which is necessary to execute the processing into a specific data area in a nonvolatile memory, a display control section configured to output display information to be displayed on a display unit on the basis of the processing executed by the processing section and a memory control section configured to erase invalid data which is unnecessary at least for the processing of data which is written in the specific data area on the basis of transition from a first state where the processing by the processing section is being executed to a second state where at least the display control section does not output the display information.

In the above information processing device, the memory control section may erase the invalid data which is unnecessary at least for the processing of the data which is written in the specific data area on the basis of a state of writing the data into the specific data area and transition from the first state to the second state.

In the above information processing device, the memory control section may erase the invalid data which is unnecessary at least for the processing of the data which is written in the specific data area on the basis of transition from the first state to the second state in a case of deciding that an amount of data which is written in the specific data area is not less than a first threshold value.

In the above information processing device, the memory control section may make the display control section output display information for giving notice on the basis of the decision in a case of deciding that the amount of data which is written in the specific data area is not less than the first threshold value.

In the above information processing device, the processing section may execute POST (Power On Self Test) processing on the basis of BIOS (Basic Input Output System) setup information in a case of starting up the information processing device and the memory control section may erase the invalid data which is unnecessary for the processing of the data which is written in the specific data area at a predetermined timing between start and termination of the POST processing in a case of deciding that the amount of data which is written in the specific data area is not less than a second threshold value.

In the above information processing device, the first threshold value may be set to a value which is larger than the second threshold value.

In the above information processing device, the memory control section may save the valid data which is necessary for the processing in the data which is written in the specific data area in a data area other than the specific data area, thereafter may erase the data which is written in the specific data area and then may write the valid data into predetermined positions in the specific data area after erasing in a case of erasing the invalid data.

In the above information processing device, the memory control section may erase the invalid data at a predetermined timing according to transition to the second state.

In the above information processing device, the memory control section may erase the invalid data before returning to the first state in accordance with a timing of returning from second state to the first state after transition to the second state.

In the above information processing device, the processing section may write the data which is necessary to execute the processing in the specific data area and a predetermined area in a volatile memory and the memory control section may erase the data which is written in the specific data area and may write the data which is necessary to execute the processing of the data which is written in the predetermined area in the volatile memory after erasing on the basis of transition from the first state to the second state.

In the above information processing device, the processing section may switch a write destination of the data which is necessary to execute the processing to either the specific data area or the predetermined area in the volatile memory on the basis of the state of writing data into the specific data area.

In the above information processing device, the processing section may write the data which is necessary to execute the processing in the specific data area in a case where the amount of data which is written in the specific data area is less than the first threshold value and may write the data which is necessary to execute the processing in the predetermined area in the volatile memory in a case where the amount of data which is written in the specific data area is not less than the first threshold value.

In the above information processing device, the memory control section may read out at least part of the data which is written in the specific data area and may write the part into the predetermined area in the volatile memory in a case of deciding that the amount of data which is written in the specific data area is not less than the first threshold value.

A controlling method of information processing device according to the second aspect of the present invention includes the step that a processing section executes processing on the basis of a predetermined program and writes data which is necessary to execute the processing in a specific data area in a nonvolatile memory, the step that a display control section outputs display information to be displayed on a display unit on the basis of the processing executed by the processing section and the step that a memory control section erases invalid data which is unnecessary at least for the processing in data which is written in the specific data area on the basis of transition from a first state where the processing by the processing section is being executed to a second state where at least the display control section does not output the display information.

A program according to the third aspect of the present invention makes a computer as the information processing device execute the step of executing processing on the basis of a predetermined program and writing data which is necessary to execute the processing in a specific data area in a nonvolatile memory, the step of outputting display information to be displayed on a display unit on the basis of the processing in a first state where the processing is being executed, the step of controlling so as not to output at least the display information in a second state and the step of erasing invalid data which is unnecessary at least for the processing in data which is written in the specific data area on the basis of transition from the first state to the second state.

The above-described aspects can appropriately control the process of saving data in the nonvolatile memory.

### BRIEF DESCRIPTION OF THE DRAWINGS

FIG. 1 is a block diagram illustrating one configuration example of an information processing device according to a first embodiment.

FIG. 2 is conceptual diagrams illustrating one example of an outline of a garbage collection process.

FIG. 3 is a flowchart illustrating one example of the garbage collection process in POST processing according to the first embodiment.

FIG. 4 is a flowchart illustrating one example of a process of giving notice of execution of the garbage collection process in a normal operating state according to the first embodiment.

FIG. 5 is a flowchart illustrating one example of the garbage collection process to be executed in a standby state according to the first embodiment.

FIG. 6 is a flowchart illustrating one example of the garbage collection process to be executed in the normal operating state according to a second embodiment.

FIG. 7 is a flowchart illustrating one example of the garbage collection process to be executed in the standby state according to the second embodiment.

### DETAILED DESCRIPTION OF THE INVENTION

In the following, embodiments of the present invention will be described in detail with reference to the drawings.

### First Embodiment

### (Configuration of Information Processing Device 10)

First, a first embodiment of the present invention will be described.

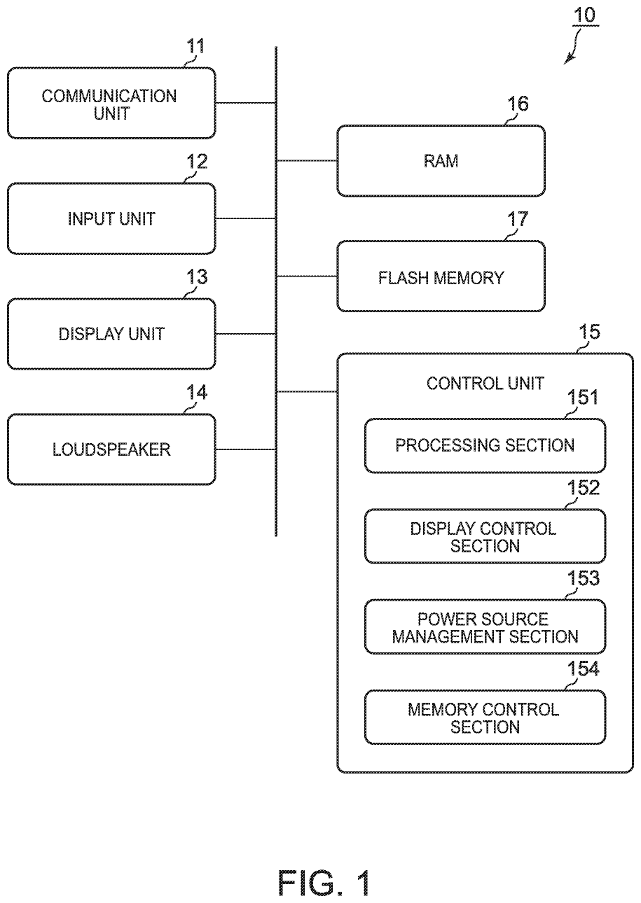

FIG. 1 is a block diagram illustrating one configuration example of the information processing device 10 according to the present embodiment. The information processing device 10 is, for example, a personal computer. The information processing device 10 may be the personal computer of any type such as, for example, the desktop type, the Laptop type, the tablet type and so forth. For example, the information processing device 10 includes a communication unit 11, an input unit 12, a display unit 13, a loudspeaker 14, a control unit 15, a RAM (Random Access Memory) 16 and a flash memory 17. These units are connected with one another to be communicable via a bus.

The communication unit 11 is configured by including digital input/output ports such as, for example, a plurality of Ethernet (a registered trademark) ports, a plurality of USBs (Universal Serial Buses) and so forth, a wireless communication network such as, for example, WiFi (a registered trademark) and so forth and others.

An operation of a user performed on a keyboard, a touch panel and so forth which are installed on a personal computer 100 is input into the input unit 12. The input unit 12 outputs an input signal which is based on the operation so input. Incidentally, the input unit 12 may be also configured integrally with the display unit 13 as a touch panel which detects an operation performed on a display screen of the display unit 13. In addition, an operation of the user which is performed on external operation devices such as, for example, a keyboard, a mouse and so forth which are connected to the personal computer 100 via the USB (Universal Serial Bus) and so forth may be input into the input unit 12.

The display unit 13 is a display which displays a video, an image, a text and so forth and is configured by including, for example, a liquid crystal display panel, an organic EL (Electroluminescence) display panel and so forth. The loudspeaker 14 outputs an electronic sound, a phonetic sound and so forth.

The control unit 15 is configured by including a CPU (Central Processing Unit) and so forth. The control unit 15 executes programs such as, for example, a BIOS (Basic Input Output System), an OS (Operating System), various applications and so forth and thereby executes various arithmetic operations, various processes and so forth. In addition, the control unit 15 performs memory control such as, for example, data writing, data erasing and so forth on the RAM 16, the flash memory 17 and so forth.

Programs and data in accordance with which the control unit 15 executes the arithmetic operations, the control, the processes and so forth are expanded on the RAM 16 and thereby saving and erasing of various kinds of data are appropriately executed. Incidentally, the RAM 16 is a volatile memory and therefore is not able to hold the data when power supply to the RAM 16 is stopped.

The flash memory 17 is a nonvolatile memory such as, for example, a flash-ROM (Read Only Memory) and so forth. That is, the flash memory 17 is able to hold the data even when power supply to the flash memory 17 is stopped. For example, the flash memory 17 is an SPI (Serial Peripheral Interface) flash memory. For example, the flash memory 17 is divided into a plurality of areas such as, for example, an area which saves a code of the BIOS, a data area (hereinafter, referred to as a “data save area”) which saves data which is necessary for a process that the control unit 15 executes and so forth.

Not only BIOS setup information and so forth which are necessary for POST (Power On Self Test) processing to be executed when booting through the BIOS is saved in the data save area in the flash memory 17, but also various kinds of data are read out of and written into the data save area in the flash memory 17 in accordance with a software program such as, for example, an OS (Operating System) and so forth also after execution of the POST processing. Updating of the same data is executed by invalidating previously written data and writing data into new areas (areas into which data is not yet written in the data save area in the flash memory 17). Therefore, since an amount of invalid data is increased every time the data is updated, an amount of data which is written in the data save area in the flash memory 17 is increased and then a free capacity of the data save area in the flash memory 17 is decreased. Therefore, the control unit 15 executes the garbage collection process at a predetermined timing.

### (Outline of Garbage Collection Process)

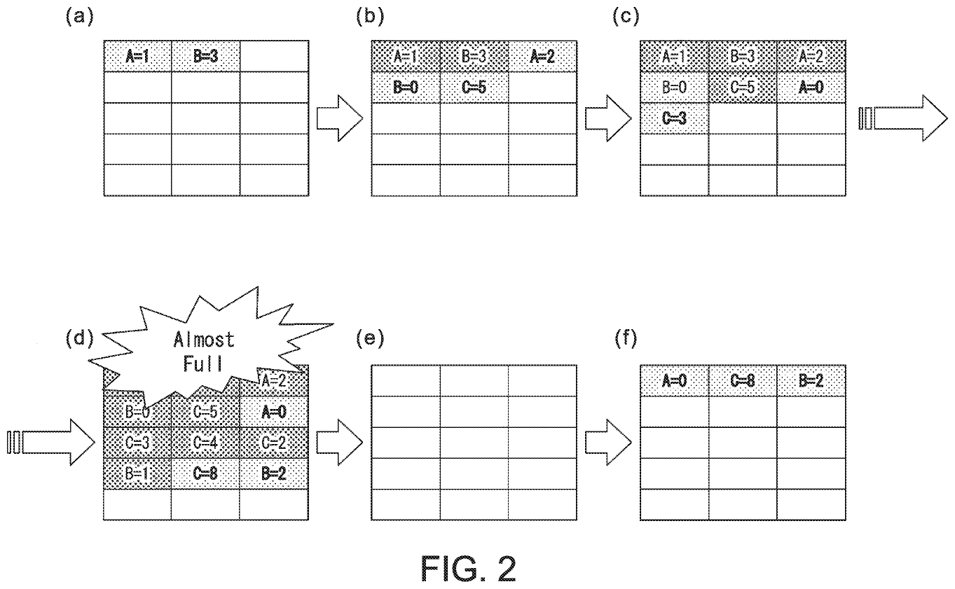

Here, the garbage collection process will be described with reference to FIG. 2. FIG. 2 is a conceptual diagram illustrating one example of an outline of the garbage collection process. Drawings illustrated in (a) to (f) of FIG. 2 illustrate states of data to be written into the data save area in the flash memory 17 in time series. Data reading out of and data writing into the data save area in the flash memory 17 are executed in units of pages and data erasing is executed in units of blocks each of which is a bundle of a plurality of pages. Although, for example, one block is configured by 64 pages and so forth, here, the data save area in the flash memory 17 is illustrated with one block being configured by 15 pages for simplicity. In the following, description will be made in order of the drawings illustrated in (a) to (f) of FIG. 2.

The control unit 15 writes “A=1” and B=2″ into the data save area in the flash memory 17 as data on A and B in a state where no data is written in the data save area in the flash memory 17 (a data-erased state). The latest data so written is also called valid data. Thereby, the data save area in the flash memory 17 is brought into a state where the data is written in areas for 2 pages in the 15 pages.

Next, in a case where the data on A and B are to be updated to “A=2” and “B=0” and “C=5” is to be newly written into the data save area in the flash memory 17 as data on C, the control unit 15 sets the previously written “A=1” and B=2″ as invalid data and writes “A=2” and “B=0” and then “C=5” into new areas (pages). That is, “A=2”, “B=0” and “C=5” become valid data. In a case of reading out each piece of data, the control unit 15 reads out the valid data without reading out the invalid data. Thereby, the data save area in the flash memory 17 is brought into a state where the data is written in areas for 5 pages in the 15 pages.

Further, in a case where the data on A and C are to be updated to “A=0” and “C=3”, the control unit 15 sets the previously written “A=2” and C=5″ as the invalid data and writes “A=0” and “C=3” into new areas (pages). That is, “A=0”, “B=0” and “C=3” become the valid data. Thereby, the data save area in the flash memory 17 is brought into a state where the data is written in areas for 7 pages in the 15 pages.

When data writing (updating) is repetitively executed, an amount of the invalid data in each block is increased and the number of data-written areas is increased. Consequently, the number of areas (pages) new data writing into which is possible is decreased and then the free capacity of the data save area in the flash memory 17 is decreased. In the example illustrated in FIG. 2, although the valid data is written in the areas for 3 pages, the invalid data is written in the areas for 9 pages and the data save area in the flash memory 17 is in a state where the data is written in the areas for 12 pages in the 15 pages. In this state, areas new data writing into which is possible are left for only 3 pages and it is decided that the data save area in the flash memory 17 is in a state where the data is written to an extent of almost filling the capacity (Almost Full). In a case where the data save area in the flash memory 17 is likely to be filled up (in a case where the free capacity is likely to become insufficient) in this way, the control unit 15 executes the garbage collection process. The state of executing the garbage collection process is decided depending on, for example, whether an amount of data written in the data save area in the flash memory 17 is not less than a predetermined threshold value.

In the garbage collection process, first, the control unit 15 moves the valid data (“A=0”, “C=3”, “B=2”) in the data which is written in the data save area in the flash memory 17 by writing the valid data into a predetermined data area other than the data save area in the flash memory 17 and thereafter erases the data in the data save area in the flash memory 17. Thereby, the data save area in the flash memory 17 is brought into a state where data is not written in all the areas for the 15 pages (that is, a data-writable state).

Next, in the garbage collection process, the control unit 15 writes back the valid data (“A=0”, “C=3”, “B=2”) which are moved to the other area (the above-described predetermined data area) back into the data save area in the flash memory 17. Since the data save area in the flash memory 17 when the valid data is to be written back into is in a free-area state where data is not written in all the pages, the valid data is closely written into the free areas (all areas) starting from an end-side page thereof. That is, the control unit 15 erases the invalid data in the data which is written in the data save area in the flash memory 17 illustrated in (d) of FIG. 2 by executing the garbage collection process and, in addition, secures a lump of free areas (data-writable areas) by moving the valid data to the end-side areas (pages) of the data save area in the flash memory 17.

Thereby, the free areas are secured in the data save area in the flash memory 17 and data writing (updating) becomes possible successively. Here, since the garbage collection process is executed through SMI (System Management Interrupt), the garbage collection process occupies the CPU and the CPU becomes unable to execute other processes. Therefore, in a case where the garbage collection process is executed in a normal operating state (for example, an S0 state which is prescribed in ACPI (Advanced Configuration and Power Interface), an application which is being executed is temporarily stopped and therefore it is not preferable to execute the garbage collection process in the normal operating state.

Accordingly, in the present embodiment, the garbage collection process is executed at a timing of execution of the POST processing that the influence is little even when the other processes are not temporarily executed and, in addition, the garbage collection process is executed in a case of transition from the normal operating state to a standby state. Here, the standby state in the present embodiment is a state which is lower than the normal operating state in power consumption and where at least display information is not output (that is, a screen-OFF state) and is an operating state which is rapidly returnable to the normal operating state. For example, the standby state may be the same as the normal operating state in operations other than the operation in the screen-OFF state, may be a state where at least some hardware operates with power consumption which is lower than that in the normal operating state in addition to the operation in the screen-OFF state and may be a state where power supply to elements other than memory-related elements is stopped. Specifically, the standby state is, for example, Modern Standby which is loaded on Windows (a registered trademark). In addition, the standby state may be, for example, an S3 (sleep) state prescribed in the ACPI. However, the standby state may not include an S4 state and an S5 state where the POST processing (a boot process) is executed when returning to the normal operating state.

### (Configuration of Control Unit 15)

In the following, the configuration of the control unit 15 which executes the garbage collection process in the POST processing and in the standby state in the present embodiment will be described in detail.

Returning to FIG. 1, the control unit 15 includes a processing section 151, a display control section 152, a power source management section 153 and a memory control section 154.

The processing section 151 executes various arithmetic operations and processes on the basis of the programs such as, for example, the BIOS. the OS, the applications which operate on the OS and so forth. When display information according to each process is to be displayed on the display unit 13, the processing section 151 instructs the display control section 152 to display the display information. In addition, the processing section 151 writes data which is necessary to execute each process into the data save area in the data-erasable/writable flash memory 17 while each of the above-described processes is being executed. Here, as described with reference to (a) to (d) in FIG. 2, in a case where the data is to be written into the data save area in the flash memory 17, the processing section 151 invalidates the previously written data and newly writes the data into the data save area in the flash memory 17. In addition, the processing section 151 executes processes/processing (the POST processing through the BIOS, OS startup and shutdown processes, a process of bringing the operating state to the standby state, a process of returning the operating state from the standby state and so forth) to be executed in association with startup and shutdown, transition to the standby state, returning from the standby state and so forth of the information processing device 10 in accordance with instructions from the power source management section 153.

The display control section 152 performs control to output various kinds of display information to be displayed on the display unit 13 on the basis of instructions from the processing section 151. For example, the display control section 152 outputs the display information to be displayed on the display unit 13 on the basis of the process executed by the processing section 151. In addition, the display control section 152 controls an ON/OFF state of output of the display information (that is, an ON/OFF state of the screen) on the basis of the instructions from the processing section 151. Incidentally, in a case where the display unit 13 is configured by including a liquid crystal display panel using a backlight, also control of an ON/OFF state of the backlight is included in the control of the ON/OFF state of output of the display information.

The power source management section 153 controls startup and shutdown, transition to the standby state, returning from the standby state and so forth of the information processing device 10. For example, in a case where an operation which is performed on a power source button is input into the input unit 12 in a power-source OFF state, the power source management section 153 transfers an instruction to start up the information processing device 10 to the processing section 151. In addition, in a case where an operation of selecting shutdown of the information processing device 10 is input into the input unit 12 in the normal operating state, the power source management section 153 transfers an instruction to shut down the information processing device 10 to the processing section 151. In addition, in a case where an operation for transition from the normal operating state to the standby state (for example, an operation of depressing the power source button or an operation of selecting the standby state) is input into the input unit 12, the power source management section 153 transfers an instruction for transition to the standby state to the processing section 151. Incidentally, in a case where setting for transition to the standby state is made on condition that no operation is input for a definite period of time, the power source management section 153 may transfer the instruction for transition to the standby state to the processing section 151 in accordance with fulfilling of the condition concerned. In addition, in a case where an operation of releasing the standby state (for example, the operation of depressing the power source button) is input into the input unit 12 in the standby state, the power source management section 153 transfers an instruction to return the information processing device 10 from the standby state to the normal operating state (an instruction to release the standby state) to the processing section 151.

The memory control section 154 executes the garbage collection process on the data save area in the flash memory 17. The garbage collection process is a process of erasing the invalid data which is unnecessary for execution of the process concerned in the data which is written in the data save area in the flash memory 17 as described above. Specifically, as described with reference to FIG. 2, the memory control section 154 saves the valid data which is necessary for execution of the process in the data which is written in the data save area in the flash memory 17 in the data area other than the data save area in the flash memory 17, thereafter erases all pieces of data in the data save area in the flash memory 17 and writes (writes back) the valid data to predetermined positions in the data save area in the flash memory 17 after erasing.

For example, the memory control section 154 executes the garbage collection process on the basis of a state of writing data into the data save area in the flash memory 17 and a predetermined timing. Here, the state of writing the data into the data save area in the flash memory 17 includes, for example, a state of an amount of data written in the data save area in the flash memory 17, a state of a free capacity (the number of free areas) of the data save area in the flash memory 17 and so forth. For example, the memory control section 154 decides whether the amount of data written in the data save area in the flash memory 17 is not less than a threshold value which is set in advance as the state of writing the data into the data save area in the flash memory 17. In addition, the predetermined timing includes a timing which is based on execution of the POST processing, a timing which is based on transition from the normal operating state to the standby state and so forth.

In the following, a threshold value used for deciding whether the garbage collection process is to be executed at the timing which is based on execution of the POST processing will be referred as a “threshold value HP”. On the other hand, a threshold value used for deciding whether the garbage collection process is to be executed at the timing which is based on transition to the standby state will be referred to as a “threshold value HS”.

For example, in a case where the memory control section 154 decides that the amount of data which is written in the data save area in the flash memory 17 is not less than the threshold value HP, the memory control section 154 executes the garbage collection process at a predetermined timing between start of execution of the POST processing and termination of execution of the POST processing. On the other hand, in a case where the memory control section 154 decides that the amount of data which is written in the data save area in the flash memory 17 is less than the threshold value HP, the memory control section 154 does not execute the garbage collection process.

In addition, in a case where the memory control section 154 decides that the amount of data written in the data save area in the flash memory 17 is not less than the threshold value HS, the memory control section 154 executes the garbage collection process on the basis of transition from the normal operating state where the process by the processing section 151 is being executed to the standby state. For example, the memory control section 154 executes the garbage collection process at a predetermined timing according to transition to the standby state. In addition, the memory control section 154 may execute the garbage collection process before returning to the normal operating state in accordance with a timing of returning from the standby state to the normal operating state after transition to the standby state. That is, the memory control section 154 may either execute the garbage collection process when entering the standby state or execute the garbage collection process when returning from the standby state. Thereby, since the garbage collection process is executed in a standby period that the display unit 13 enters at least the screen-OFF state, the influence on the user is little.

The threshold value HP and the threshold value HS are threshold values used for deciding whether the garbage collection process is to be executed in order to avoid such a situation that the data save area in the flash memory 17 is filled up and execution of the process concerned becomes impossible. However, since the influence of temporal stopping of the POST processing which is exerted on the user is little, the threshold value HP used in the POST processing may be set in such a manner that the garbage collection process is positively executed also at a stage that there is some room still left in the free capacity of the data save area in the flash memory 17 so as to avoid necessity of execution of the garbage collection process as much as possible after startup. On the other hand, the threshold value HS used in the standby state may be set in such a manner that the garbage collection process is executed at a stage that the data save area in the flash memory 17 is filled to some extent so as not to impede a normal operation as much as possible because the information processing device 10 is in an already-started-up state. That is, for example, the threshold value HS is set to a value which is larger than the threshold value HP.

Incidentally, a relation between the threshold value HS and the threshold value HP is not limited to the above and, for example, the threshold value HS and the threshold HP may be set to the same value and the threshold value HP may be set to a value which is larger than the threshold value HS.

In addition, in a case where the memory control section 154 decides that the amount of data which is written in the data save area in the flash memory 17 is not less than the threshold value HS, the memory control section 154 may make the display control section 152 output display information for giving notice on the basis of the above-described decision and may make the display unit 13 display the display information.

For example, in a case where the memory control section 154 decides that the amount of data which is written in the data save area in the flash memory 17 is not less than the threshold value HS, the memory control section 154 may make the display unit 13 display the display information which indicates notice of such a content that the garbage collection process will be executed when entering the standby state or when returning from the standby state. The notice of the content that the garbage collection process will be executed is, for example, “Data which is not used in the memory will be erased in the next standby state”, “The memory will be cleaned up in the next standby state” and so forth.

In addition, in a case where the memory control section 154 decides that the amount of data which is written in the data save area in the flash memory 17 is not less than the threshold value HS, the memory control section 154 may make the display unit 13 display notice of such a content that the memory is insufficient as the display information. In addition, the memory control section 154 may make the display unit 13 display notice of encouraging the user to bring the information processing device 10 into the standby state, to restart the information processing device 10 and so forth as the display information in place of or in addition to the notice of the content that the memory is insufficient.

### Operations of Processes in First Embodiment

Next, the operations of the processes to be executed relating to the garbage collection process will be described.

### (Operations of Processes in Execution of POST Processing)

First, the operations of the processes that the control unit 15 executes for execution of the garbage collection process in the POST processing at the startup will be described.

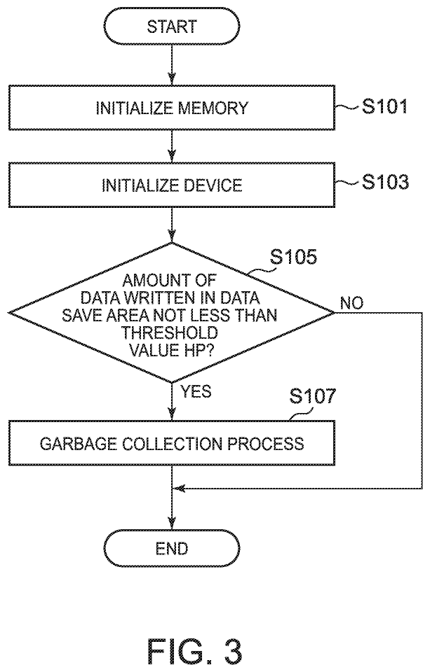

FIG. 3 is a flowchart illustrating one example of the garbage collection process in the POST processing according to the present embodiment.

(Step S101) The control unit 15 starts the POST processing by executing a BIOS-based program and executes a memory initialization process. Then, the control unit 15 proceeds to a process of step S103.

(Step S103) The control unit 15 acquires information (for example, vendor information, device information and communication establishment information) relating to a device which is connected to a TBT (Thunderbolt) element on the basis of the acquired information, detects the device connected to the TBT element and executes a device initialization process. Then, the control unit 15 proceeds to a process of step S105.

(Step S105) The control unit 15 decides whether the amount of data which is written into the data save area in the flash memory 17 is not less than the threshold value HP.

For example, in a case where the control unit 15 decides that the amount of data written in the data save area in the flash memory 17 is not less than the threshold value HP (YES), the control unit 15 proceeds to a process of step S107. On the other hand, in a case where the control unit 15 decides that the amount of data which is written in the data save area in the flash memory 17 is less than the threshold HP (NO), the control unit 15 terminates execution of the POST processing without executing the process of step S107.

(Step S107) The control unit 15 executes the garbage collection process on the data save area in the flash memory 17 and thereafter terminates execution of the POST processing.

### (Operations of Processes in Normal Operating State)

Next, the operations of the processes that the control unit 15 executes in a process of giving notice of such a content that the garbage collection process will be executed to the user in a case where the amount of data which is written in the data save area in the flash memory 17 becomes not less than the threshold value HS in the normal operating state will be described.

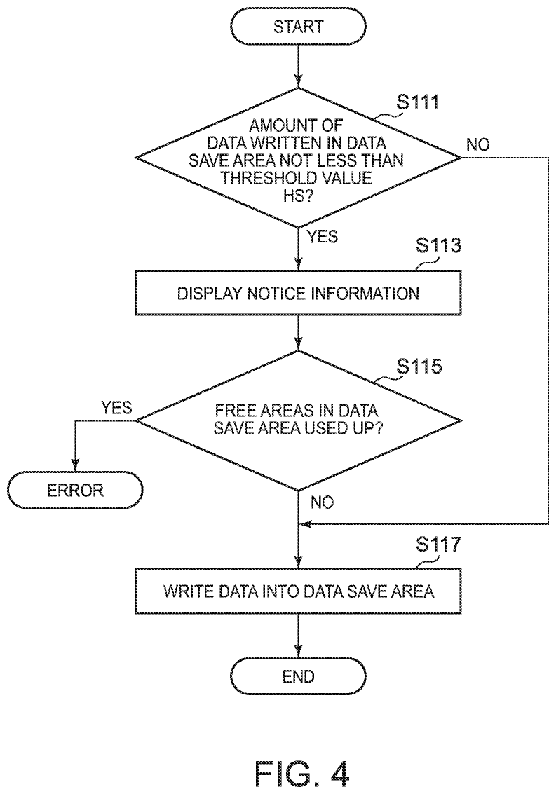

FIG. 4 is a flowchart illustrating one example of the process of giving notice for execution of the garbage collection process in the normal operating state according to the present embodiment.

(Step S111) The control unit 15 decides whether the amount of data written in the data save area in the flash memory 17 in the normal operating state is not less than the threshold value HS. For example, in a case where the control unit 15 decides that the amount of data which is written in the data save area in the flash memory 17 is not less than the threshold value HS (YES), that is, in a case where the control unit 15 decides that the data save area becomes “Almost Full”, the control unit 15 proceeds to a process of step S113. On the other hand, in a case where the control unit 15 decides that the amount of data written in the data save area in the flash memory 17 is less than the threshold value HS (NO), the control unit 15 proceeds to a process of step S117 without executing processes of step S113 to step S115.

(Step S113) The control unit 15 outputs display information for giving notice on the basis of the decision in step S111 and makes the display unit 13 display the display information. For, example, the control unit 15 makes the display unit 13 display the display information indicating notice of such a content that the garbage collection process will be executed when entering the standby state or when returning from the standby state. Then, the control unit 15 proceeds to the process of step S115.

(Step S115) The control unit 15 decides whether the free areas in the data save area in the flash memory 17 are used up (that is, the data save area becomes “Full”). For example, in a case where the control unit 15 decides that the free areas in the data save area in the flash memory 17 are used up (YES), the control unit 15 is not able to execute a normal operation and terminates with error. On the other hand, in a case where the control unit 15 decides that the free areas in the data save area in the flash memory 17 are not used up (NO), the control unit 15 proceeds to the process of step S117.

(Step S117) The control unit 15 appropriately writes data which is necessary for execution of the process concerned into the data save area in the flash memory 17 in accordance with the process which is being executed.

### (Operations of Processes in Standby State)

Next, the operations of the processes that the control unit 15 executes in order to execute the garbage collection process in a case of transition from the normal operating state to the standby state will be described.

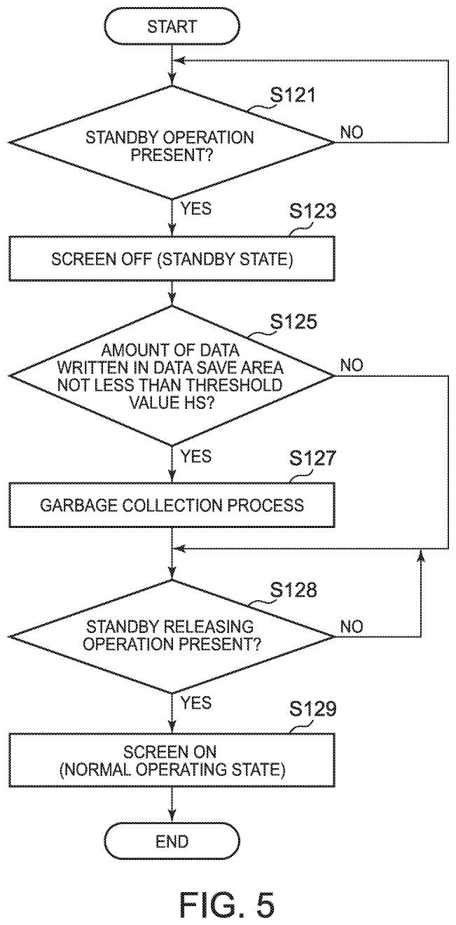

FIG. 5 is a flowchart illustrating one example of the garbage collection process to be executed in the standby state according to the present embodiment.

(Step S121) The control unit 15 decides presence/absence of input of an operation (depression of the power source button and so forth) for transition to the standby state in the normal operating state. For example, in a case where the control unit 15 decides that the operation for transition to the standby state is not input (NO), the control unit 15 again executes a process of step S121. On the other hand, in a case where the control unit 15 decides that the operation for transition to the standby state is input (YES), the control unit 15 proceeds to a process of step S123.

(Step S123) The control unit 15 makes the state transition from the normal operating state to the standby state. For example, the control unit 15 stops output of at least the display information and controls the display unit 13 to the screen-OFF state. Then, the control unit 15 proceeds to a process of step S125.

(Step S125) The control unit 15 decides whether the amount of data written in the data save area in the flash memory 17 is not less than the threshold HS. For example, in a case where the control unit 15 decides that the amount of data which is written in the data save area in the flash memory 17 is not less than the threshold value HS (YES), the control unit 15 proceeds to a process of step S127. On the other hand, in a case where the control unit 15 decides that the amount of data which is written in the data save area in the flash memory 17 is less than the threshold value HS (NO), the control unit 15 proceeds to a process of step S128 without executing a process of step S127.

(Step S127) The control unit 15 executes the garbage collection process on the data save area in the flash memory 17 and proceeds to a process of step S128.

(Step S128) The control unit 15 decides presence/absence of input of an operation (depression of the power source button and so forth) for releasing the standby state in the standby state. For example, in a case where the control unit 15 decides that the operation for releasing the standby state is not input (NO), the control unit 15 executes again the process of the step S128. On the other hand, in a case where the control unit 15 decides that the operation for releasing the standby state is input (YES), the control unit 15 proceeds to a process of step S129.

(Step S129) The control unit 15 makes the state transition from the standby state to the normal operating state and controls the display unit 13 to a screen-ON state.

Incidentally, although in the processes illustrated in FIG. 5, an example of executing the garbage collection process when entering the standby state was described, the garbage collection process may be executed when returning from the standby state. In this case, the order of the process of step S127 and the process of step S128 illustrated in FIG. 5 is changed and in a case where the control unit 15 decides that the operation for releasing the standby state is input, the control unit 15 executes the garbage collection process and thereafter makes the state transition to the normal operating state and controls the display unit 13 to the screen-ON state.

In addition, in the process executed in the normal operating state which is described with reference to FIG. 4, in a case where the control unit 15 decides that the amount of data which is written in the data save area in the flash memory 17 is not less than the threshold value HS, the control unit 15 makes the display unit 13 display the notice which is based on the decision. Alternatively, the notice which is based on the decision may not be displayed on the display unit 13. That is, the control unit 15 may execute the garbage collection process when the state transitions to the standby state without giving the notice to the user.

In addition, the control unit 15 may execute the garbage collection process without confirming the amount of data which is written in the data save area in the flash memory 17. For example, in the POST processing and when transitioning to the standby state, the control unit 15 may execute the garbage collection process without confirming the amount of data which is written in the data save area in the flash memory 17.

As described above, the control unit 15 of the information processing device 10 according to the present embodiment includes the processing section 151, the display control section 152 and the memory control section 154. The processing section 151 executes the process concerned on the basis of the predetermined program and writes the data which is necessary for execution of the process into the data save area (one example of a specific data area) in the flash memory 17 (one example of the nonvolatile memory). The display control section 152 outputs the display information to be displayed on the display unit 13 on the basis of the process executed by the processing section 151. The memory control section 154 erases the invalid data which is unnecessary at least for execution of the process in the data which is written in the data save area in the flash memory 17 on the basis of transition from the normal operating state (one example of a first state) where the process by the processing section 151 is being executed to the standby state (one example of a second state) where at least the display control section 152 does not output the display information.

Thereby, the information processing device 10 is able to increase the free capacity by erasing the invalid data which is written in the data save area in the flash memory 17 when the state transitions to the standby state without temporarily interrupting the process which is being executed in the normal operating state. Accordingly, the information processing device 10 is able to suppress shortage of the free capacity of the data save area in the flash memory 17 without impeding execution of the process in the normal operating state irrespective of a utilization method of again using the information processing device 10 simply by bringing the device 10 into the standby state without shutting down the device 10 when not used and therefore is able to appropriately control the process of saving the data in the data save area in the flash memory 17.

For example, the memory control section 154 erases the invalid data which is unnecessary at least for execution of the process concerned in the data which is written in the data save area in the flash memory 17 on the basis of a state of writing data into the data save area (one example of the specific data area) in the flash memory 17 and transition from the normal operating state (one example of the first state) to the standby state (one example of the second state). Here, the state of writing the data into the data save area in the flash memory 17 includes the state of the amount of data which is written in the data save area in the flash memory 17, the state of the free capacity (the number of free areas) of the data save area in the flash memory 17 and so forth.

Thereby, the information processing device 10 is able to increase the free capacity by erasing the invalid data which is written in the data save area in the flash memory 17 on the basis of transition to the standby state before the data save area in the flash memory 17 is filled up.

For example, in a case where the memory control section 154 decides that the amount of data written in the data save area (one example of the specific data area) in the flash memory 17 is not less than the threshold value HS (the first value), the memory control section 154 erases the invalid data which is unnecessary at least for execution of the process in the data written in the data save area in the flash memory 17 on the basis of transition from the normal operating state (one example of the first state) to the standby state (one example of the second state).

Thereby, in a case where the amount of data written in the data save area in the flash memory 17 exceeds a definite value, the information processing device 10 is able to increase the free capacity by erasing the invalid data which is written in the data save area in the flash memory 17 when the state transitions to the standby state. That is, in a case where the data save area in the flash memory is likely to become Full, the information processing device 10 is able to increase the free capacity in the standby state and to continue the operation in a state where the free capacity of the data save area is increased after returning from the standby.

Incidentally, in a case where the memory control section 154 decides whether the free capacity of the data save area is less than a predetermined threshold value and decides that the free capacity is less than the predetermined threshold value, the memory control section 154 may erase the invalid data which is unnecessary at least for execution of the process concerned in the data written in the data save area in the flash memory 17 on the basis of transition from the normal operating state (one example of the first state) to the standby state (one example of the second state).

In addition, specifically, in a case where the invalid data is to be erased, the memory control section 154 saves the valid data which is necessary for execution of the process concerned in the data which is written in the data save area (one example of the specific data area) in the flash memory 17 in the data area other than the data save area in the flash memory 17, thereafter erases the data which is written in the data save area in the flash memory 17 and then writes the valid data to predetermined positions in the data save area in the flash memory 17 after erasing.

Thereby, the information processing device 10 is able to leave the valid data in the data which is written in the data save area in the flash memory 17 and to bring the areas for the erased invalid data into a data-writable state as free areas.

In addition, the memory control section 154 erases the invalid data in the data save area in the flash memory 17 at a predetermined timing according to transition to the standby state (one example of the second state).

Thereby, the information processing device 10 is able to increase the free capacity by erasing the invalid data in the data save area in the flash memory 17 when entering the standby state.

Incidentally, after transition to the standby state (one example of the second state), the memory control section 154 may erase the invalid data in the data save area in the flash memory 17 before returning to the normal operating state in accordance with a timing of returning from the standby state to the normal operating state (one example of the first state).

Thereby, the information processing device 10 is able to increase the free capacity by erasing the invalid data in the data save area in the flash memory 17 when retuning from the standby state.

In addition, in a case where the memory control section 154 decides that the amount of data which is written in the data save area (one example of the specific data area) in the flash memory 17 is not less than the threshold value HS (the first threshold value), the memory control section 154 makes the display control section 152 output display information for giving notice on the basis of the decision.

Thereby, the information processing device 10 is able to give notice of such contents that the data save area in the flash memory 17 approaches the full state, the garbage collection process will be executed (cleaning-up of the memory will be executed) in the next transition to the standby state and so forth to the user. In addition, the information processing device 10 is able to persuade the user so as to make the state transition to the standby state such that an error may not occur due to insufficient memory by giving notice of such a content that the memory is insufficient to the user.

Incidentally, the information processing device 10 may give notice to the user stepwise as the data amount is increased by preparing the plurality of threshold values used for deciding the amount of data written in the data save area in the flash memory 17.

In addition, when starting up the information processing device 10, the processing section 151 executes the POST processing on the basis of BIOS setup information. Then, in a case where the memory control section 154 decides that the amount of data which is written in the data save area (one example of the specific data area) in the flash memory 17 is not less than the threshold value HP (the second threshold value), the memory control section 154 erases the invalid data which is unnecessary for execution of the process concerned in the data which is written in the data save area in the flash memory 17 at the predetermined timing between start of execution of the POST processing and termination of execution of the POST processing.

Thereby, in a case of being shut down, the information processing device 10 is able to increase the free capacity by erasing the invalid data which is written in the data save area in the flash memory 17 at the later start-up.

For example, the threshold value HS (the first threshold value) which is used in the above-described standby state is set to a value which is larger than the threshold value HP (the second threshold value) used in the above-described POST processing.

Thereby, since influence on the user is little even when the garbage collection process is executed in the POST processing, the information processing device 10 is able to increase the free capacity by positively erasing the invalid data which is written in the data save area in the flash memory 17 at the stage that some room is still left in the free capacity of the data save area in the flash memory 17 and, in the standby state, is able to increase the free capacity by erasing the invalid data which is written in the data save area in the flash memory 17 at the stage that the data save area is filled to some extent so as not to impede the normal operation as much as possible.

### Second Embodiment

Next, the second embodiment of the present invention will be described. In the first embodiment, the free capacity of the data save area is secured without impeding the process executed in the normal operating state by executing the garbage collection process on the data save area in the flash memory 17 in the standby state. However, there are some processes which are continuously executed when the state transitions from the normal operating state to the standby state. For example, there are cases where irrespective of transition to the standby state while music is being reproduced, a process of reproducing the music is continuously executed. When the garbage collection process is executed in such a situation, it becomes necessary to temporarily interrupt execution of the reproducing process and an interruption time is prolonged depending on the data amount. It is not desirable that the time for which reproduction of the music is interrupted be prolonged when entering the standby state while the user is listening to the music. Therefore, in the present embodiment, a process of making the time taken for execution of the garbage collection process as short as possible in a case of executing the garbage collection process in the standby state will be described. Specifically, in the present embodiment, the time taken for execution of the garbage collection process on the data save area in the flash memory 17 is reduced by utilizing the RAM 16 as a virtual flash memory.

Incidentally, the basic configuration of the information processing device 10 according to the present embodiment is the same as the configuration described in the first embodiment and illustrated in FIG. 1. Here, processes which are different from the processes in the first embodiment will be described. In a case of executing the garbage collection process on the data save area in the flash memory 17, the control unit 15 utilizes the RAM 16.

Specifically, the processing section 151 writes data which is necessary for execution of the process concerned into the data save area in the flash memory 17 and, in addition, writes the data also into a predetermined area in the RAM 16 in a case where a predetermined condition is fulfilled. Here, the predetermined area is an area which is set in advance in the RAM 16 as an area to be utilized as the virtual flash memory. For example, in a case where the amount of data written in the data save area in the flash memory 17 is not less than the threshold value HS, the processing section 151 writes the data which is necessary for execution of the process into the predetermine area in the RAM 16 without writing the data into the data save area in the flash memory 17. On the other hand, in a case where the amount of data which is written in the data save area in the flash memory 17 is less than the threshold value HS, the processing section 151 writes the data which is necessary for execution of the process into the data save area in the flash memory 17.

For example, in a case where the amount of data which is written in the data save area in the flash memory is less than the threshold value HS, the processing section 151 writes the data which is necessary for execution of the process into the data save area in the flash memory 17. In a case where the memory control section 154 decides that the amount of data which is written in the data save area in the flash memory 17 is not less than the threshold value HS, the memory control section 154 reads out the data which is written in the data save area in the flash memory 17 and writes the read-out data into the predetermined area in the RAM 16. That is, the memory control section 154 copies the data which is written in the data save area in the flash memory 17 to the predetermined area in the RAM 16. In addition, the memory control section 154 erases the invalid data in the data which is copied to the predetermined area in the RAM 16, extracts the valid data from the data which is copied to the predetermined area in the RAM 16 and writes the extracted data to the predetermined positions of the above-described predetermined area in the RAM 16 (for example, packing the data into the predetermined area one after another). Then, the memory control section 154 makes the switch so as to make the RAM 16 function as the virtual flash memory. In the following, control for making the switch so as to make the RAM 16 function as the virtual flash memory will be also referred as “switching ON the virtual flash memory (the RAM)”. On the other hand, control for not making the RAM 16 function as the virtual flash memory will be also referred as “switching OFF the virtual flash memory (the RAM)”.

When the virtual flash memory (the RAM) is controlled to switch ON by the memory control section 154, the processing section 151 writes the data which is necessary for execution of the process into the predetermined area in the RAM 16 without writing the data into the data save area in the flash memory 17. That is, in a case where the amount of data which is written in the data save area in the flash memory 17 is not less than the threshold value HS, the processing section 151 writes the data which is necessary for execution of the process into the predetermined area in the RAM 16 without writing the data into the data save area in the flash memory 17.

Thereafter, the memory control section 154 erases the data which is written in the data save area in the flash memory 17 on the basis of transition from the normal operating state to the standby state. Then, after erasing the data which is written in the data save area in the flash memory 17, the memory control section 154 writes the valid data which is necessary for execution of the process in the data which is written in the predetermined area in the RAM 16 into the data save area in the flash memory 17.

Thereby, the data in the data save area in the flash memory 17 is sorted out and the free areas are secured. In addition, the garbage collection process which is executed in the standby state in the present embodiment is the process of simply erasing the data in the data save area in the flash memory 17 and writing the valid data from the predetermined area in the RAM 16 into the data save area in the flash memory 17. Accordingly, in the present embodiment, it is possible to more reduce the time taken for execution of the process than a case of temporarily moving the valid data from the data save area in the flash memory 17 and thereafter performing data erasing and writing-back of the valid data as in the garbage collection process which is executed in the standby state in the first embodiment. In addition, in a case where the amount of data which is written in the data save area in the flash memory 17 is not less than the threshold value HS, the processing section 151 writes the valid data which is necessary for execution of the process into the predetermined area in the RAM 16 and therefore it becomes possible to avoid such a situation that the process which is being executed is not normally continued due to shortage of the free capacity of the data save area in the flash memory 17 even when the normal operating state is continuously maintained.

### Operations of Processes in the Second Embodiment

Next, the operations of the processes to be executed relating to the garbage collection process according to the present embodiment will be described. Incidentally, since the operation in the POST processing is the same as the operation in the first embodiment, description thereof is omitted. Here, an operation of a process executed in the normal operating state and an operation of a process executed in the standby state will be described.

As described above, in the present embodiment, in a case where the amount of data which is written in the data save area in the flash memory 17 becomes not less than the threshold value HS in the normal operating state, the control unit 15 moves the valid data to the predetermined area in the RAM 16 and utilizes the predetermined area in the RAM 16 as the area in the virtual flash memory. In addition, the control unit 15 executes the garbage collection process of erasing the data which is written in the data save area in the flash memory 17 in the standby state and writing the valid data from the predetermined area in the RAM 16 into the data save area in the flash memory 17 after erasing the data. First, the operations of the processes to be executed relating to the garbage collection process in the normal operating state will be described.

### (Operations of Processes in the Normal Operating State)

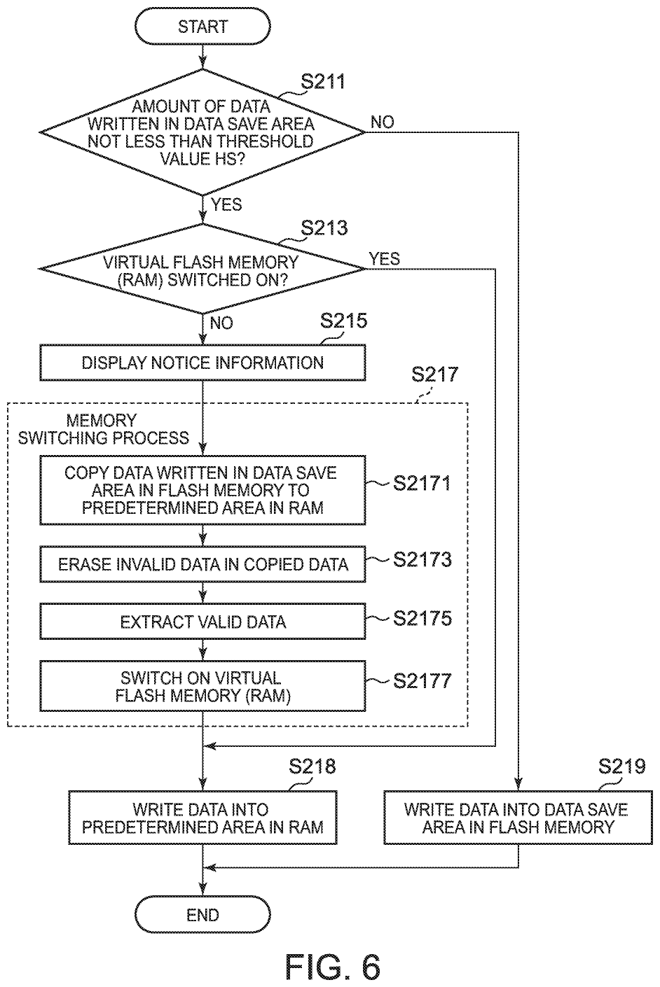

FIG. 6 is a flowchart illustrating one example of the garbage collection process (a memory switching process) in the normal operating state according to the present embodiment.

(Step S211) The control unit 15 decides whether the amount of data which is written in the data save area in the flash memory 17 in the normal operating state is not less than the threshold value HS. For example, in a case where the control unit 15 decides that the amount of data which is written in the data save area in the flash memory 17 is not less than the threshold value HS (YES), that is, in a case where the control unit 15 decides that the data save area becomes “Almost Full”, the control unit 15 proceeds to a process of step S213. On the other hand, in a case where the control unit 15 decides that the amount of data which is written in the data save area in the flash memory 17 is less than the threshold value HS (NO), the control unit 15 proceeds to a process of step S219.

(Step S213) The control unit 15 decides whether the virtual flash memory (the RAM) is switched ON. In a case where it is decided that the virtual flash memory (the RAM) is already switched ON (YES), the control unit 15 proceeds to a process of step S218. On the other hand, in a case where it is decided that the virtual flash memory (the RAM) is switched OFF (NO), the control unit 15 proceeds to a process of step S215.

(Step S215) The control unit 15 outputs display information for giving notice on the basis of the decision in step S213 and makes the display unit 13 display the display information. For example, the control unit 15 makes the display unit 13 display the display information indicating notice of such a content that the garbage collection process will be executed when entering the standby state or when returning from the standby state and then proceeds to a process of step S217.

(Step S217) The control unit 15 executes the memory switching process of making the switch so as to make the RAM 16 function as the virtual flash memory.

Specifically, the control unit 15 executes processes of step S2171 to step S2177 which are indicated in the following.

(Step S2171) The control unit 15 reads out the data which is written in the data save area in the flash memory 17 and writes (copies) the read-out data into (to) the predetermined area in the RAM 16 and then proceeds to the process of step S2173.

(Step S2173) The control unit 15 erases the invalid data in the data which is copied to the predetermined area in the RAM 16 and proceeds to the process of step S2175.

(Step S2175) The control unit 15 extracts the valid data in the data which is copied to the predetermined area in the RAM 16 and writes the extracted valid data to the predetermined positions of the above-described predetermined area in the RAM 16 (for example, packing the data into the predetermined area one after another) and then proceeds to the process of step S2177.

(Step S2177) The control unit 15 controls to switch ON the virtual flash memory (the RAM) and makes the switch so as to make the RAM 16 function as the virtual flash memory.

(Step S218) In a state where the virtual flash memory (the RAM) is switched ON (in a case of YES in step S213 or after execution of the process of step S2177), the control unit 15 appropriately writes the data which is necessary for execution of the process into the predetermine area in the RAM 16 in accordance with the process which is being executed.

(Step S219) In a case where the virtual flash memory (the RAM) is switched OFF (NO in step S221), the control unit 15 appropriately writes the data which is necessary for execution of the process into the data save area in the flash memory 17 in accordance with the process which is being executed.

Incidentally, in the memory switching process in step S217 illustrated in FIG. 6, the control unit 15 may extract only the valid data in the data which is written in the data save area in the flash memory 17 and may write the extracted valid data to the predetermined positions in the predetermine area in the RAM 16 (for example, packing the data into the predetermined area one after another).

### (Operations of Processes in the Standby State)

Next, the operations of the processes to be executed relating to the garbage collection process in the standby state will be described.

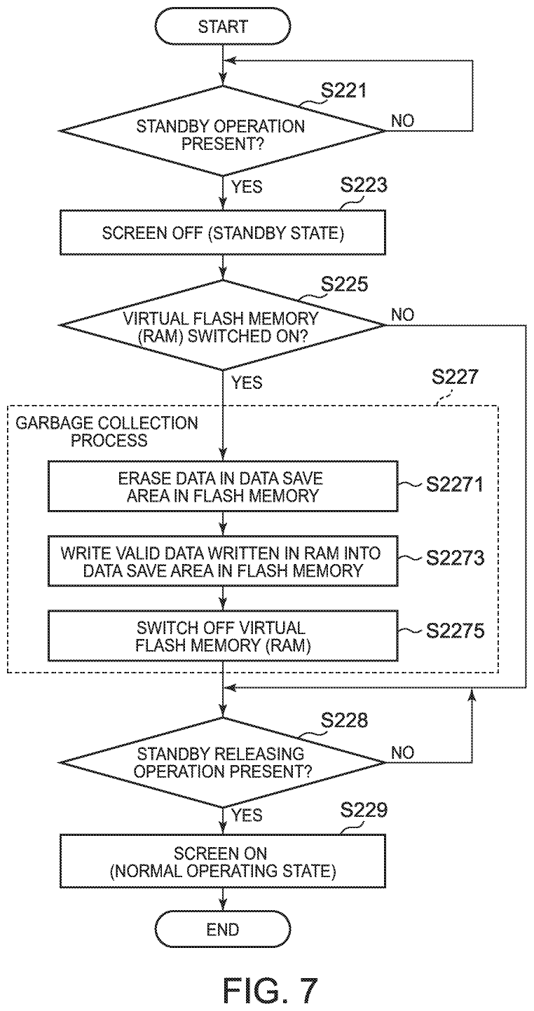

FIG. 7 is a flowchart illustrating one example of the garbage collection process in the standby state according to the present embodiment.

(Step S221) The control unit 15 decides presence/absence of input of an operation (depression of the power source button and so forth) of making the state transition to the standby state in the normal operating state. For example, in a case where the control unit 15 decides that the operation of making the state transition to the standby state is not input (NO), the control unit 15 executes again the process of step S221. On the other hand, in a case where the control unit 15 decides that the operation of making the state transition to the standby state is input (YES), the control unit 15 proceeds to a process of step S223.

(Step S223) The control unit 15 makes the state transition from the normal operating state to the standby state. For example, the control unit 15 stops output of at least the display information, controls the display unit 13 to the screen-OFF state and then proceeds to a process of step S225.

(Step S225) The control unit 15 decides whether the virtual flash memory (the RAM) is switched ON. In a case where it is decided that the virtual flash memory (the RAM) is switched ON (YES), the control unit 15 proceeds to a process of step S227 and executes the garbage collection process. On the other hand, in a case where it is decided that the virtual flash memory (the RAM) is switched OFF (NO), the control unit 15 does not execute the garbage collection process and proceeds to a process of step S229.

(Step S227) The control unit 15 executes the garbage collection process on the data save area in the flash memory 17. Specifically, the control unit 15 executes processes of step S2271 to step S2275 which are indicated in the following.

(Step S2271) The control unit 15 erases the data which is written in the data save area in the flash memory 17 and proceeds to the process of step S2273.

(Step S2273) The control unit 15 writes the valid data which is written in the predetermine area in the RAM 16 into the data save area in the flash memory 17 and proceeds to the process of step S2275.

(Step S2275) The control unit 15 controls to switch OFF the virtual flash memory (the RAM) to cause the RAM 16 not to function as the virtual flash memory. That is, in the subsequent processes, the control unit 15 writes the data which is necessary for execution of the process into the data save area in the flash memory 17.

(Step S228) The control unit 15 decides presence/absence of input of an operation of releasing the standby state (depression of the power source button and so forth) in the standby state. For example, in a case where the control unit 15 decides that the operation of releasing the standby state is not input (NO), the control unit 15 executes again the process of step S228. On the other hand, in a case where the control unit 15 decides that the operation of releasing the standby state is input (YES), the control unit 15 proceeds to a process of step S229.

(Step S229) The control unit 15 makes the state transition from the standby state to the normal operating state and controls the display unit 13 to the screen-ON state.

Incidentally, although in the process illustrated in FIG. 7, an example of executing the garbage collection process when entering the standby state was described, the garbage collection process may be executed when returning from the standby state. In this case, the order of the process of step S227 and the process of step S228 illustrated in FIG. 7 is changed, and in a case where the control unit 15 decides that the operation of releasing the standby state is input, the control unit 15 executes the garbage collection process and then makes the state transition to the normal operating state and controls the display unit 13 to the screen-ON state.

As described above, in the information processing device 10 according to the present embodiment, the processing section 151 writes the data which is necessary for execution of the above-described process into the data save area (one example of the specific data area) in the flash memory 17 (one example of the nonvolatile memory) and into the predetermined area in the RAM 16 (one example of the volatile memory). Specifically, the processing section 151 switches a data writing destination to one of the data save area in the flash memory 17 and the predetermined area in the RAM 16 on the basis of the state of writing data into the data save area in the flash memory 17. On the other hand, in a case where the amount of data which is written in the data save area in the flash memory 17 is not less than the threshold value HS (the first threshold value), the processing section 151 writes the data into the predetermined area in the RAM 16.

Thereby, the information processing device 10 switches the data writing destination to the RAM 16 before the data save area in the flash memory 17 is filled up and therefore is able to avoid such a situation that the process which is being executed is not normally continued due to lack of the free capacity of the data save area in the flash memory 17 even when the normal operating state is continuously maintained. Accordingly, the information processing device 10 is able to appropriately control the process of saving the data in the data save area in the flash memory 17.

In addition, in a case where the memory control section 154 decides that the amount of data which is written in the data save area in the flash memory 17 is not less than the threshold value HS (the first threshold value), the memory control section 154 reads out at least part of the data which is written in the data save area in the flash memory 17 and writes the read-out part into the predetermined area in the RAM 16.

Thereby, the information processing device 10 is able to save the valid data which is saved in the data save area in the flash memory 17 before switching the data writing destination to the RAM 16 together with the valid data which is written in the predetermined area in the RAM 16 after switching the data writing destination to the RAM 16 in the RAM 16.

Then, the memory control section 154 erases the data which is written in the data save area in the flash memory 17 on the basis of transition from the normal operating state (one example of the first state) to the standby state (one example of the second state) and writes the valid data which is written in the predetermined area in the RAM 16 into the data save area in the flash memory 17 after erasing the above-described data. That is, the memory control section 154 executes the garbage collection process on the data save area in the flash memory 17 using the valid data in the predetermined area in the RAM 16.

Thereby, the information processing device 10 is able to secure the free areas by sorting out the data in the data save area in the flash memory 17 at the timing of transition to the standby state. In addition, although the information processing device 10 saves the data by temporally utilizing the RAM 16, data saving into the predetermined area in the RAM 16 becomes impossible when power supply to the RAM 16 is stopped. Accordingly, the information processing device 10 is able to return a data saving (writing) destination to the data save area in the flash memory 17 by executing the garbage collection process at the timing of transition to the standby state and thereby is able to improve safety. Incidentally, even in a case where power supply stoppage occurs before returning the data saving destination to the flash memory 17, the data which is saved in the data save area in the flash memory 17 before switching the data saving destination to the RAM 16 is left in the data save area in the flash memory 17 and therefore it is possible to recover data by using the data which is saved at that time.

In addition, the garbage collection process to be executed in the standby state in the present embodiment is completed simply by erasing the data in the data save area in the flash memory 17 and writing the valid data from the predetermined area in the RAM 16 into the data save area in the flash memory 17 and therefore it is possible to more shorten the time taken for execution of the garbage collection process than the time attained in the first embodiment.

Although the first and second embodiments of the present invention were described in detail with reference to the drawings as above, the specific configurations are not limited to the above-described configurations and various design changes and so forth are possible within a range not deviating from the gist of the present invention. For example, the configurations described in the first and second embodiments may be optionally combined with each other/one another.

In addition, in the above-described embodiments, when executing the garbage collection process on the basis of the state of writing data into the data save area in the flash memory 17, the information processing device 10 decides whether the garbage collection process is to be executed depending on whether the amount of data which is written in the data save area in the flash memory 17 exceeds the definite value. Alternatively, whether the garbage collection process is to be executed may be decided on the basis of the free capacity of the data save area in the flash memory 17. For example, the information processing device 10 may control to execute the garbage collection process at the timing of execution of the POST processing or transition to the standby state in a case where the free capacity of the data saved area in the flash memory 17 becomes less than a predetermined threshold value and may control so as not to execute the garbage collection process in a case where the free capacity of the data save area in the flash memory 17 is not less than the predetermined threshold value. That is, the state of writing data into the data save area in the flash memory 17 may be either a state of the amount of data which is written in the data save area in the flash memory 17 or a state of the free capacity of the data save area in the flash memory 17.

In addition, in the above-described embodiments, the information processing device 10 executes the garbage collection process on the basis of the state of writing data into the data save area in the flash memory 17. Alternatively, the garbage collection process may be typically executed in execution of the POST processing or in the standby state irrespective of the state of writing data into the data save area in the flash memory 17.

Incidentally, the above-described information processing device 10 includes a computer system therein. Then, the processes in the respective configurations that the above-described information processing device 10 includes may be also executed by recording a program for realizing functions of the respective configuration that the above-described information processing device 10 includes in a computer readable recording medium, making the computer system read the program which is recorded in the recording medium and executing the program. Here, “making the computer system read the program which is recorded in the recording medium and executing the program” includes installation of the program into the computer system. “The computer system” which is described here shall include the OS and hardware such as peripherals and so forth. In addition, “the computer system” may also include a plurality of computer devices which are connected with each other/one another over a network including communication lines such as, for example, the Internet, a WAN, a LAN, a private line and so forth. In addition, “the computer readable recording medium” means portable media such as, for example, a flexible disk, a magneto-optical disk, a ROM, a CD-ROM and so forth and storages such as, for example, a hard disk and so forth built in the computer system. The recording medium which stores the program in this way may be a non-transitory recording medium such as, for example, the CD-ROM and so forth.

In addition, the recording medium also includes internally and externally disposed recording media which are accessible from a distribution server for distribution of the program concerned. Incidentally, configurations in accordance with which the program is divided into a plurality of parts and the divided parts of the program are downloaded at mutually different timings and thereafter are integrated together by respective configurations that the information processing device 10 includes and the distribution servers which distribute the divided parts of the program respectively may be different from one another respectively. Further, “the computer readable recording medium” shall also include media which each hold the program for a definite period of time such as, for example, the sever in a case where the program is transmitted over the network and the volatile memory (the RAM) built in the computer system which serves as a client. In addition, the above-described program may be also the one adapted to implement some of the above-described functions. Further, the program may be also the one which is able to implement the above-described functions by being combined with a program which is already recorded in the computer system, that is, a so-called a differential file (a differential program).

In addition, some or all of the respective functions that the information processing device 10 according to the above-described embodiments includes may be realized as an integrated circuit such as, for example, an LSI (Large Scale Integration) and so forth. The respective functions may be individually processorized and some or all of the functions may be integrated with one another and then processorized. In addition, an approach for circuit integration may be realized by a private circuit, a general-purpose processor and so forth, not limited to the LSI. In addition, in a case of appearance of a technique for realizing an integrated circuit which would take the place of the LSI owing to progress of the semiconductor technology, the integrated circuit realized by the above-described technique may be used.

1. An information processing device comprising:
a processing section configured to execute processing on the basis of a predetermined program and to write data which is necessary to execute the processing into a specific data area in a nonvolatile memory;
a display control section configured to output display information to be displayed on a display unit on the basis of the processing executed by the processing section; and
a memory control section configured to erase invalid data which is unnecessary at least for the processing of data which is written in the specific data area, the erasing being on the basis of transition from a first state where the processing by the processing section is being executed to a second state where at least the display control section does not output the display information.

2. The information processing device according to claim 1, wherein:
the memory control section:
erases the invalid data which is unnecessary at least for the processing of the data which is written in the specific data area on the basis of a state of writing the data into the specific data area and transition from the first state to the second state.

3. The information processing device according to claim 2, wherein:
the memory control section:
erases the invalid data which is unnecessary at least for the processing of the data which is written in the specific data area on the basis of transition from the first state to the second state, when an amount of data which is written in the specific data area is not less than a first threshold value.

4. The information processing device according to claim 3, wherein:
the memory control section:
makes the display control section output display information for giving notice on the basis of the decision, when the amount of data which is written in the specific data area is not less than the first threshold value.

5. The information processing device according to claim 3, wherein:
the processing section:
executes POST (Power On Self Test) processing on the basis of BIOS (Basic Input Output System) setup information when starting up the information processing device and
the memory control section:
erases the invalid data which is unnecessary for the processing of the data which is written in the specific data area at a predetermined timing between start and termination of the POST processing, when the amount of data which is written in the specific data area is not less than a second threshold value.

6. The information processing device according to claim 5, wherein:
the first threshold value is set to a value which is larger than the second threshold value.

7. The information processing device according to claim 1, wherein:
the memory control section:
saves the valid data which is necessary for the processing of the data which is written in the specific data area in a data area other than the specific data area, thereafter erases the data which is written in the specific data area, and then writes the valid data into predetermined positions in the specific data area after erasing, when erasing the invalid data.

8. The information processing device according to claim 1, wherein:
the memory control section:
erases the invalid data at a predetermined timing according to transition to the second state.

9. The information processing device according to claim 1, wherein:
the memory control section:
erases the invalid data before returning to the first state in accordance with a timing of returning from the second state to the first state after transition to the second state.

10. The information processing device according to claim 1, wherein:
the processing section:
writes the data which is necessary to execute the processing into the specific data area and a predetermined area in a volatile memory; and
the memory control section:
erases the data which is written in the specific data area and writes the data which is necessary to execute the processing in the data which is written in the predetermined area in the volatile memory after erasing on the basis of transition from the first state to the second state.

11. The information processing device according to claim 10, wherein:
the processing section:
switches a write destination of the data which is necessary to execute the processing to either the specific data area or the predetermined area in the volatile memory on the basis of the state of writing data into the specific data area.

12. The information processing device according to claim 11, wherein:
the processing section:
writes the data which is necessary to execute the processing into the specific data area when the amount of data which is written in the specific data area is less than the first threshold value, and writes the data which is necessary to execute the processing into the predetermined area in the volatile memory when the amount of data which is written in the specific data area is not less than the first threshold value.

13. The information processing device according to claim 10, wherein:
the memory control section:
reads out at least part of the data which is written in the specific data area and writes the part of the data into the predetermined area in the volatile memory when the amount of data which is written in the specific data area is not less than the first threshold value.

14. A controlling method of information processing device comprising:
processing on the basis of a predetermined program and writes data which is necessary to execute the processing into a specific data area in a nonvolatile memory;
outputting display information to be displayed on a display unit on the basis of the processing executed by the processing section; and
erasing invalid data which is unnecessary at least for the processing of data which is written in the specific data area on the basis of transition from a first state where the processing is being executed to a second state where at least a display control section does not output the display information.

15. A program configured to make a computer execute:
a step of executing processing on the basis of a predetermined program and writing data which is necessary to execute the processing into a specific data area in a nonvolatile memory;
a step of outputting display information to be displayed on a display unit on the basis of the processing in a first state where the processing is being executed;
a step of controlling so as not to output at least the display information in a second state; and
a step of erasing invalid data which is unnecessary at least for the processing of data which is written in the specific data area on the basis of transition from the first state to the second state.
